(19) United States
(12) Patent Application Publication
(10) Pub. No.: US 2003/0028432 A1
(43) Pub. Date: Feb. 6, 2003

(54) Method for the customization of commercial product placement advertisements in digital media

(75) Inventors: Lidror Troyansky, Ramat Gan (IL); Ariel Peled, Even Yehuda (IL); Ofir Carny, Kochav Yair, IL (US); Joshua Porath, Benyamina (IL)

Correspondence Address: G.E. EHRLICH (1995) LTD., c/o ANTHONY CASTORINA, 2001 JEFFERSON DAVIS HIGHWAY, SUITE 207, ARLINGTON, VA, 22202, US

(73) Assignee: Vidius Inc.

(21) Appl. No.: 10/208,866

(22) Filed: Aug. 1, 2002

Related U.S. Application Data
(60) Provisional application No. 60/308,816, filed on Aug. 1, 2001.

(51) Int. Cl. G06F 17/60

(52) U.S. Cl. 705/14

(57) ABSTRACT

A method for dynamic embedding of objects into context selectable locations in digital media items to form versions of said digital media items, said method comprising the steps of: finding context suitable locations in said visual media; dynamically selecting a subset of said objects for at least one location; and embedding one object of said subset of objects in said at least one location, thereby to form a version of said digital media item.

### CROSS-REFERENCE TO RELATED APPLICATIONS

This application is related to and claims priority from U.S. Provisional Patent Application No. 60/308,816, filed Aug. 1, 2001, the contents of which are hereby incorporated by reference.

### FIELD OF THE INVENTION

The present invention relates generally to the field of customized placement of product-related material, known as product placement, in digital media. More specifically, the present invention deals with methods by which a specific digital media item, containing a variety of product placement type advertising within, can be adapted and customized in real time so as to target several types of demographically distinct clients simultaneously.

### BACKGROUND OF THE INVENTION

Product placement is a method for advertising and positioning of an advertisement or other product-related material by embedding the product-related material in a segment of content, such as a frame-sequence or a scene in motion pictures or a paragraph in a book, in a manner that seems to be realistic, that is to say in a manner that implies some kind of support from the context of the segment. The audiences of the content view are therefore exposed to the product in a complimentary context that empowers the advertised brand.

Product placement is an important aspect of marketing in providing the advertised brand or product with a relevant environment that enhances the advertising effect. Furthermore, the use of such advertising mode enables advertisers to achieve the targets of the act of advertising and/or promotion, without interfering with the course of the media event and disturbing the viewer, thus increasing the quality of user experience on one hand, while decreasing the viewer's antagonism towards the advertisement on the other.

Using present techniques, product placing is usually an irreversible procedure, especially in motion pictures: done only once during the filmmaking process, or in a lengthy, complicated post-production procedure, and can only be displayed with the specific product. This fact poses serious limitations on the business model, as the ‘place’ for a product can usually be sold only once, to one advertiser. This lack of flexibility does not allow for any leeway or dynamics in the pricing scheme.

As opposed to advertising in ad breaks within the content, current technologies do not allow the customization of the content of product placement, for different types of viewing audience, or over a period. This is clearly the case in the entertainment industry, where most productions are intended to be consumed for the longest possible time—often years. With the current rigidity of product placement technologies, the placed product may soon become obsolete. This leads to a situation where over time a growing portion of the viewing audience may be targeted with an irrelevant or outdated message, thus reducing the promotional value of the product placement. This is a bigger problem when there is a need to advertise a limited time offer, or when the advertiser is willing to pay premium rates for advertisements, but only for a limited period.

Furthermore, the loss is even greater when considering the fact that targeted advertising, i.e. advertising that is more adapted to the viewing/consuming audience, can reap greater revenues to publishers. This lack of ability to easily update product placement in the future means loss of potential revenues from product placement advertising for publishers and/or copyrights owners, for example in re-runs of shows.

Digital video, especially in “download” mode poses another challenge for explicit advertising: in many cases, the user can skip ads spots and clusters (e.g., by using specialized software). On the other hand, implicit advertising that is based on product positioning, is not prone to skipping.

With the proliferation of media channels, the growth of worldwide audiences, the easiness of access to media items and the ability to descend to a resolution at the level of the single user the potential of revenue from product placement advertising, for publishers and owners of digital media content, would appear to increase. Yet, the potential for product placement advertising remains unchanged due to the lack of ability to adapt products placed in media content to various segments of the audience, or to update them with time.

A method for the on-line customization of the brands placed in media content, at user level resolution, based on a user client's demographic profile, pricing and other requirements of the advertiser can therefore be of tremendous commercial importance.

### PRIOR ART

Ads customization of pre-determined ads breaks are addressed, e.g., by U.S. Pat. No. 5,933,811, which proposes a system and method for delivering customized advertisements within interactive communication, the customized advertisements are selected based on consumer profiles and are then integrated with offerings maintained by different content providers. The preferred interactive communication system interconnects multiple consumer computers, multiple content provider computers and multiple Internet provider computers with an advertisement provider computer. The custom advertisement is then combined with the offering from the content provider computer and displayed to the consumer. The system described relates generally to advertisements attached, as advertisements, to interactive content rather than advertising messages or brand images embedded within a video media content and do not address the topic of the current invention, namely product placement.

U.S. Pat. No. 6,020,931 proposes a video composition and position system and media signal communication system. This system makes possible or renders more economical the combination of a video signal with virtual studio, blue screen, multi-color composting, dynamic blue screen, add insertion, synthetic transfiguration, or panoramic displays, into specific tine slots within die video content. A router is used in conjunction with the interface subsystems to define the time slots in which data on the shared communications channels arc valid. Processing elements connected via the interface subsystem allow reconfiguration, via the shared communications channels, of processing operations performed. This system, however, does not directly relate to product positioning nor to advertiser's demands vs. a multiplicity of target audiences.

U.S. Pat. No. 5,917,830 proposes a system for splicing compressed packetized digital video streams (such as advertisements) within video content, and is particularly suitable for use within a cable network to allow the insertion of commercials from local businesses into a nationally broadcast television program. The system does not apply to endorsements embedded within the media content but to time slots pre-defined for advertisements (as in ad breaks). Added to that, the proposed system does not apply to a situation in which a multiplicity of advertisers apply, in real time, advertisements to a multiplicity of users.

U.S. Pat. No. 5,859,660 offers a system for non-seamless splicing of audio-video transport streams configured in accordance with MPEG-2 or other suitable techniques where a first transport stream is to be spliced with a second transport stream at a splice point. The first stream is configured such that the final first stream frame to be displayed will be a black frame Or will have another suitable characteristic. Null packets are then delivered in place of the first stream transport packets for a predetermined period of time after the splice point. The predetermined time is generally greater than the sum of the splice decoding delay associated with the splice point and the maximum frame duration in the first stream. The transport packets of the second stream are then delivered. Null packets may be again delivered for a period of time sufficient to allow tie final frame of the second stream to be displayed. The final first stream frame can be guaranteed to be a black frame by directing a digital stream insertion device to insert a black 1-frame followed by an end-of-sequence code into the first stream. This system, however, does not address advertisers need for targeting multiple ads to multiple target audience profile types.

U.S. Pat. No. 5,600,366 also proposes methods and apparatus for digital advertisement insertion in video programming which permit digital ad insertion in timely and correct switchovers from network programming to local advertising in ways which occur smoothly without a disruption in perception to the viewer. Switchovers occur at packet or frame boundaries and are designed to occur upon detection of idle information from a network source. This patent also does not address product placement as such.

The above patents and applications do not relate directly to product placement and do not allow for the online simultaneous customization of product placement type advertising.

There is thus a recognized need for, and it would be highly advantageous to have, a method and system that allows customized product placement and commercial endorsement, which will overcome the drawbacks of current methods as described above.

### SUMMARY OF THE INVENTION

A method for dynamic product placement advertising in digital media (such as digital video, e-books and audio books) is presented. The basic concept is based on first locating (off-line) slots where one or more product brands can be positioned, then producing two or more copies of the slot and embedding the two or more product brands (e.g., two or more brands of canned soft-drinks) in said slots. The copies may thereafter be packed in libraries or directories and stored on a storage device. A customized copy of the content that contains an optimized sequence of brands, can thereafter be produced on-line by selecting the corresponding copies and embedding them in the content (e.g., by concatenating files of digital video). As a result, a sequence of alternating products placed within digital media content is created, which may create a distinction between copies of the same content title, as they are directed to a diverse target audience.

In another embodiment of the present invention, the production of several copies of a video slot is performed while shooting the video. According to a first aspect of the present invention there is provided a method for dynamic embedding of objects into context selectable locations in digital media items to form versions of the digital media items, the method comprising the steps of:

finding context suitable locations in the visual media;

dynamically selecting a subset of the objects for at least one location; and

embedding one object of the subset of objects in the at least one location, thereby to form a version of the digital media item.

In another embodiment of the present invention, the object comprises visual representation of at least one of the following:

a product;

a logo;

the name of a product;

the name of a company;

a text related to a product;

a text related to a company;

an object related to a company; and

an object related to a product.

In another embodiment of the present invention, the digital media item is video.

In another embodiment of the present invention, the digital media item is a still image.

In another embodiment of the present invention, the location includes a location in time and a geometric location, the location in time being a subset of the duration of the video.

In another embodiment of the present invention, at least one of the locations comprises an existing object within the visual content, and the object being embedded, replaces the existing object.

In another embodiment of the present invention, at least one of the objects is a void object designed to bc used when no other object is selected for the location.

In another embodiment of the present invention, the object selection is additionally for representing information.

In another embodiment of the present invention, the information comprises forensic information.

In another embodiment of the present invention, the digital media is any one of a group comprising: video, still image, audio, and written media.

In another embodiment of the present invention, the selection is based on information about at least one the following:

viewers of the visual content;

preferences of viewers of the visual content;

preferences of advertisers;

demographics of the viewers of the visual content;

subject-matter of the digital media item;

atmosphere induced by the digital media item;

content of the objects to be embedded;

interests of viewers of the digital media item

products being the subject of the objects to be embedded.

In another embodiment of the present invention, at least some of the information is stored in a database.

In another embodiment of the present invention the method comprising preparing alternative versions of the digital media item by making alternative object selections for each version.

In another embodiment of the present invention, the digital media is arranged in layers, and at least some of the advertisement objects are embedded in separate layers. In another embodiment of the present invention, the digital media is at least partially generated by computer, based on scene representation, at least some of the objects to be embedded are also based on a scene representation, and at least some of the generating is done after the embedding of the objects.

In another embodiment of the present invention, the scene representation comprises at least one of the following:

a three dimensional scene representation;

an object based representation;

an object based representation which further comprises interaction between objects

an object based representation that further comprises physical interaction between objects.

In another embodiment of the present invention, the method further comprises the steps of:

analyzing the visual content;

locating at least one replaceable object in the visual content;

selecting at least one replaceable object in the visual content; and

embedding the objects to be embedded by replacing at least some of the replaceable objects with the objects to be embedded.

In another embodiment of the present invention, the analyzing comprises analyzing at least one of the following properties:

lighting;

shading;

texture;

object orientation and location;

relative object location;

object movement;

frame panning,

frame zooming;

frame rotation;

refraction;

transparency;

focus

reflection,

and the step of embedding the advertisement objects by replacing the replaceable objects is done in a manner optimizing the retention of at least some of the properties, thereby to enhance the realism in the produced visual content.

In another embodiment of the present invention, at least one of the advertisement objects is represented by a three dimensional model.

According to a second aspect of the present invention there is provided a system for dynamic embedding of at least one embeddable object in digital media, the embeddable object is to be embedded in a manner designed to be perceived as an integral part of the digital media and thereby to form different versions of the digital media, the system comprising:

a locator operable to find at least one location in the visual content contextwise suitable for objects of a group to which the embeddable object belongs;

a selector operable to dynamically select objects from the group; and

an embedding mechanism operable to embed the selected object in the contextwise suitable location.

In another embodiment of the present invention, the embeddable object comprises visual representation of at least one of the following:

a product;

a logo;

the name of a product;

the name of a company;

a text related to a product;

a text related to a company;

an object related to a company; and

an object related to a product.

In another embodiment of the present invention, the digital media is video.

In another embodiment of the present invention, the digital media is a still image.

In another embodiment of the present invention, the location includes a location in time and a geometric location, the location in time being a subset of the duration of the video content.

In another embodiment of the present invention, at least one of the locations comprises an included object in the digital media, and the advertisement object when embedded in the location, replaces the object.

In another embodiment of the present invention, at least one of the embeddable objects is a null object designed to be used when no other object is selected for the location.

In another embodiment of the present invention, the selector is further operable to make the selection to represent information.

In another embodiment of the present invention, the information comprises forensic information.

In another embodiment of the present invention, the selection done by the selector is based on information about at least one the following:

viewers of the digital media;

preferences of viewers of the digital media;

preferences of advertisers;

demographics of viewers of the digital media;

subject-matter of the digital media;

content of the digital media;

atmosphere induced by the digital media;

content of the embeddable objects;

interests of viewers of the digital media

products that are the subjects of the embeddable objects.

In another embodiment of the present invention, further comprising a database operable to store at least some of the information.

In another embodiment of the present invention, operable to prepare several versions of at least part of the digital media by embedding different ones of the embeddable objects.

In another embodiment of the present invention, the digital media comprises layers, and at least some of the embeddable objects are embedded in separate layers.

In another embodiment of the present invention, the visual content is at least partially generated by computer based on scene representation, at least some of the embeddable objects are also based on a scene representation, the visual content is created by generating the scene representation and at least some of the generating is done after the embedding of the advertisement objects by the embedding mechanism.

In another embodiment of the present invention, the scene representation comprises at least one of the following:

a three dimensional scene representation;

an object based representation;

an object based representation which further comprises interaction between objects

an object based representation that further comprises physical interaction between objects.

In another embodiment of the present invention, the system further comprises an analyzer for analyzing the visual content, the locator is operable to locate at least one replaceable object in the digital media based on information provided by the analyzer, the selector is operable to select located replaceable object in the digital media, and the embedding mechanism is operable to embed the embeddable object by replacing at least some of the replaceable objects with the embeddable object.

In another embodiment of the present invention, the analyzer is operable to analyze for at least one of the following properties:

lighting;

shading;

texture;

object orientation and location;

relative object location

object movement;

frame panning;

frame zooming;

frame rotation;

refraction;

transparency;

focus

reflection,

and the embedding by the embedding mechanism is done in a manner optimizing the retention of at least some of the properties, thereby to enhance realism of the embedding.

In another embodiment of the present invention, at least one of the embeddable objects is represented by a three dimensional model.

According to a third aspect of the present invention there is provided a method for dynamic embedding of at least one embeddable object into verbal digital media content the embeddable object is embedded in a manner designed to be perceived as an integral part of the verbal content, the method comprising the steps of:

finding at least one location in the digital verbal content which is contextwise associable with a type of object;

dynamically selecting an embeddable object being of the type; and

embedding the selected embeddable object in the contextwise associable location.

In another embodiment of the present invention, the embeddable objects comprises verbal representation of at least one of the following:

the name of a product;

the name of a company;

a text related to a product, and

a text related to a company.

In another embodiment of the present invention, the verbal content is audio content.

In another embodiment of the present invention, the verbal content is textual content.

In another embodiment of the present invention, at least one of the locations comprises an existing object within the verbal content, and the embeddable object, when embedded in the location, replaces the existing object.

In another embodiment of the present invention, at least one of the advertisement objects is a null object designed to be used when no advertisement object is selected for the location.

In another embodiment of the present invention, the selecting is further operable to represent information.

In another embodiment of the present invention, the information comprises forensic information.

In another embodiment of the present invention, the selection is based on information about at least one the following:

users of the verbal content;

preferences of the users of the verbal content;

preferences of advertisers;

demographics of users of the verbal content;

subject-matter of the verbal content;

atmosphere induced by the verbal content;

content of the embeddable objects;

interests of users of the verbal content

products represented by the embeddable objects.

In another embodiment of the present invention, at least some of the information is stored in a database.

In another embodiment of the present invention, several versions of at least part of the verbal content are prepared by embedding different objects therein.

In another embodiment of the present invention, the verbal content comprises layers, and at least some of the objects are embedded in separate layers.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow-chart of the off-line customization stage, constructed and operative in accordance with a preferred embodiment of the present invention;

FIG. 2 is a simplified block-diagram of basic system for customized product placement, constructed and operative in accordance with a preferred embodiment of the present invention;

FIG. 3 is a schematic illustration of the preprocessing sub-system, constructed and operative in accordance with a preferred embodiment of the present invention;

FIG. 4 is a flowchart of the on-line customization stage, operative in accordance with a preferred embodiment of the present invention;

FIG. 5 is a schematic illustration of a decision support system used in order to obtain an optimized advertising session, constructed and operative in accordance with a preferred embodiment of the present invention, and

FIG. 6 is a schematic illustration of a system for on-line embedding of a system for customized product placement, constructed and operative in accordance with another preferred embodiment of the present invention.

### DETAILED DESCRIPTION OF PREFERRED EMBODIMENTS

The present embodiments seek to provide a system and a method for on-line, real-time personalized product-placement type advertisements.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to he understood that the phraseology and terminology employed herein is for the purpose of description and should not be regarded as limiting.

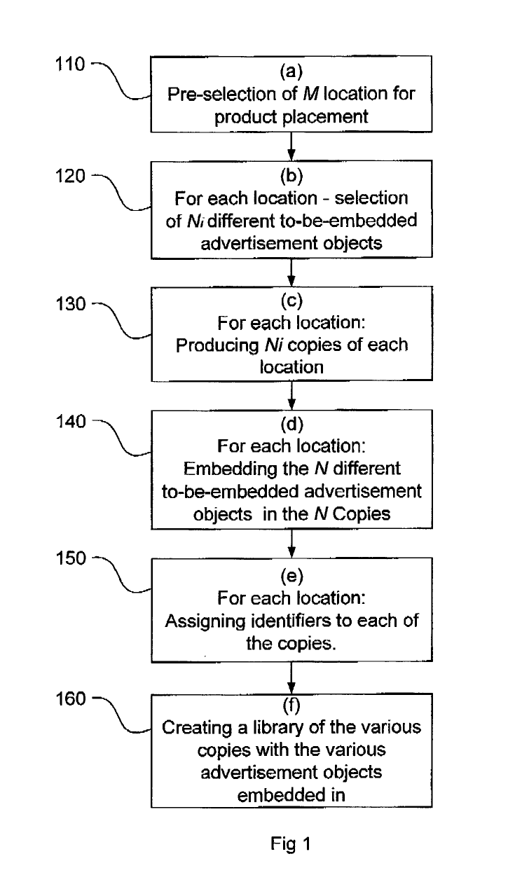

Reference is first made to FIG. 1, which is a flow-chart that describes the sequence of operations that are performed by the preprocessing sub-system: the process of dynamic product placement starts with the manual and/or automated identification of placements slots within the digital media content (stage a, indicated by 110). After locating the slots, the advertisement objects that can be located in the slots are identified (e.g., cereal box or a soft-drink can in a video scene, a car model or a name of a hotel in a detective book, etc.) (stage b, indicated by 120). Each slot is then duplicated N times (stage c, indicated by 130), where N is the number of various advertisement objects or the to-be-embedded product type (e.g., various brands of soft-drinks cans or cereal boxes). The advertisement objects arc accordingly embedded in the various copies (stage d, indicated by 140). At the next stage, an identifier is assigned to each of the copies (stage e, indicated by 150). in order to allow for a fast and efficient recall. At the next stage, a library of the said copies, together with their identifiers, is created (stage f, indicated by 160) and the copies are stored on a storage device.

In another embodiment of the present invention, the production of several copies of a video slot is performed while shooting the video.

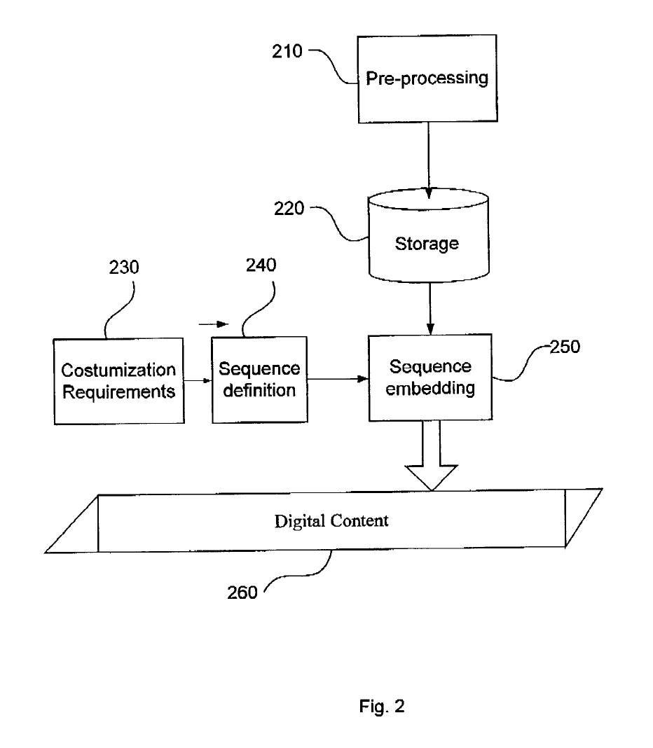

FIG. 2 is an overall view of the system's components. The preprocessing sub-system 210 prepares two or more copies of selected segments; each of them is embedded with (preferably) different advertisement objects (e.g., different brands of the same product) positioned in a manner that is optimal for promoting sales of the brand. After embedding, the products are stored in a storage device 220, such as a hard-disk of a computer. When a user, or a group of users want to view or purchase a digital copy (e.g., a video-on-demand or a copy of an e-book) the system defines a set of customization requirements 230, which determine which brand should be place in each of the slots. The sequence definition module 240 preferably slates these requirements into a sequence of identifiers. The sequence-embedding module 250 uses these identifiers in order to obtain the required copies from the storage 220 and to embed them into a version of the digital content 260 to be sent to the user.

In a preferred embodiment of the present invention, the object comprises visual representation of at least one of the following:

a product;

a logo;

the name of a product;

the name of a company;

a text related to a product;

a text related to a company;

an object related to a company; and

an object related to a product.

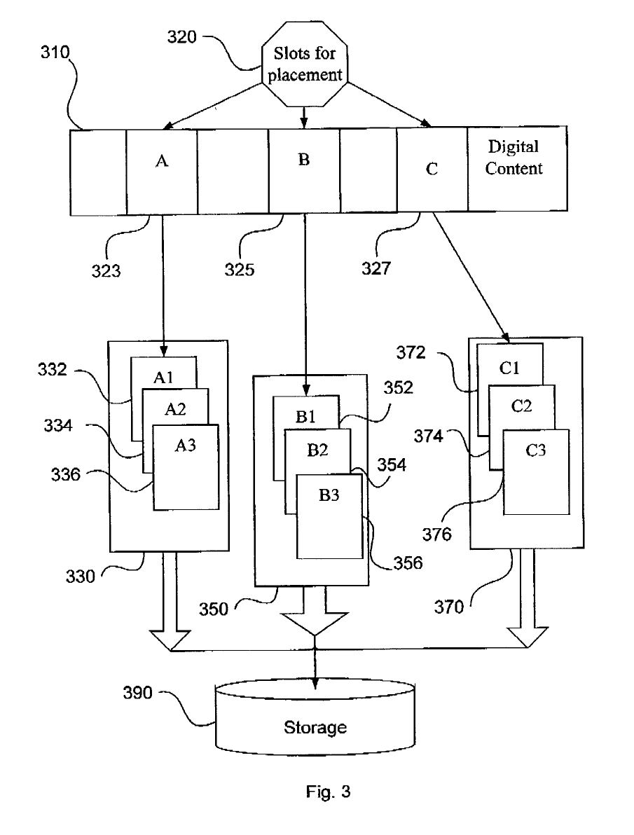

Reference is now made to FIG. 3, which is a schematic illustration of the preprocessing stage: A digital media content item 310 is analyzed to locate and identify a set of segments 320 (e.g., video scenes) that are suitable for product placement. Each adequate frame/scene (e.g., 323,325,327) is preferably designated as a placement slot and may be characterized in terms that describe the physical conditions of the segment such as (for a video frame): size of place for the product, lighting, color, camera angle and distance, movement, continuity and other visual aspects. The characterization process attempts to assure maximum coherency between the placed advertisement object the digital media content. Each segment Sᵢ is then replicated Nᵢ times, where Nᵢ is the number of various product brands that have been found suitable for placement in the segment Sᵢ. Each copy is thereafter used for embedding a different product brand. The method for embedding can be any suitable post-production method, such as postproduction replacement in a blue box, elimination of moving objects, chroma-key or similar methods or else previously prepared (on camera) sequences/shots/scenes in which the product is replaced. The system preferably always defines a default for placement in each slot. A default placement may be an unmarked or unbranded product, in case there is no advertisement available. Copies of the same slot (332-336, 352-356, 372-376) are packed in the corresponding directories (330, 350 and 370) and stored in a storage device 390.

In a preferred embodiment of the present invention, the analysis process that is used to assure the coherency between the said digital media and said advertisement objects comprises analyzing at least one of the following properties:

lighting;

shading;

texture;

object orientation and location;

relative object location;

object movement;

frame panning;

frame zooming;

frame rotation;

refraction;

transparency;

focus

reflection,

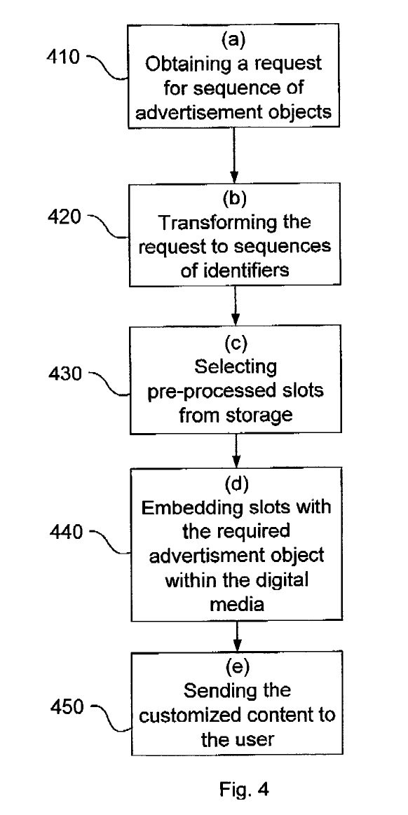

Reference is now made to FIG. 4, which is a flowchart of the online process of preparing customized copy of contents with embedded brands. The process is started by obtaining a request for embedding of a specific sequence of advertisement objects in the digital content (stage a, indicated by 410). The request may be an output of a decision support subsystem, based on demographic data, on specific requirements from advertising agencies, on a user's requests or on any other source. The request is translated into a sequence of identifiers (stage b, indicated by 420) that are used in order to select pre-processed slot copies from storage (stage c, indicated by 430). The pre-processed slots are thereafter embedded in the digital media (stage d, indicated by 440). In a preferred embodiment of the present invention, the slots are packed and compressed as video files (e.g., according to an MPEG standard or the like) and the process of embedding is based on concatenating the selected files (that is the copies of the slots with a certain brands embedded inside) with other files containing the context, in order to produce a file that contains the customized version. The customized version is thereafter sent to a user or to a group of users (stage e, indicated by 450).

In a preferred embodiment of the present invention, the preprocessing stage is assisted by maintaining a database of brand specification, describing the physical aspects of the product brands prepared for placement, using terms similar to those used for defining a content slot. Several images of the same brand, prepared in different modes (different angle, lighting etc.) may be stored in a brand database in order to facilitate the embedding process.

In another embodiment of the system the system holds a database of user (viewers) characteristics, defined by a set of demographic terms similar to those used by advertisers. Demographic data may originate from the user, upon requesting the media item or from outside sources interfacing with the system. The user, from the point of view of the media distributor, may also be a group of actual users who share similar traits, and are therefore treated together.

In another embodiment of the system, each product image may also carry a price tag, which is the maximum price the advertiser is willing to pay for placing the product. The price may vary depending on the targeting level (i.e. the amount of data accumulated on a specific user)

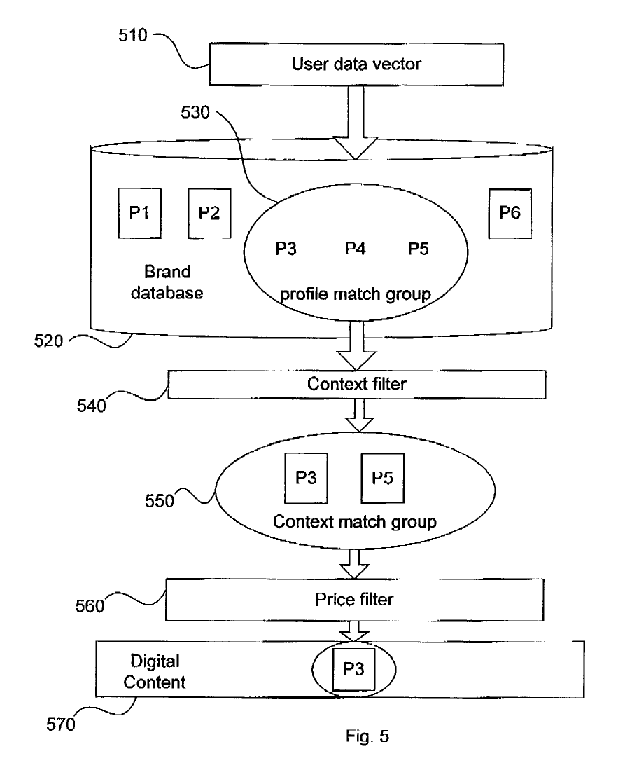

Reference is now made to FIG. 5, which illustrates a decision support system that may be used in order to obtain an optimized advertising session using product placement of various brands. The system first obtains user's demographic profile vector 510, either directly from the user or from the user profile database. The system then prompts brands from brand database 520 that matches the user's profile according to predetermined target requirements, and from the prompted brands, the system creates a profile match group 530. The profile match group thus provides a cluster of potential products or brands that match the requesting user's profile. The products or brands in the profile match group may than be examined by a context filter 540, which maintain the 20 coherency of the session—e.g., in case of a conflict between brands, the context filter may eliminates some of the brands in order to reduce the level of the conflict. The remaining brands become a context match group 550. the context match group may be filtered again using a price filter 560 to check each product's price tag and finally select brands which have: (1) The highest price tag and/or (2) A priority set by the system administrator (for example—FIFO in advertising order date). These brands will thereafter be embedded in the digital content 570.

In a preferred embodiment of the present invention, the decision system utilizes information about at least one the following:

viewers of the visual content;

preferences of viewers of the visual content;

preferences of advertisers;

demographics of the viewers of the visual content;

subject-matter of the digital media item;

atmosphere induced by the digital media item;

content of the objects to be embedded;

interests of viewers of the digital media item

products being the subject of the objects to be embedded.

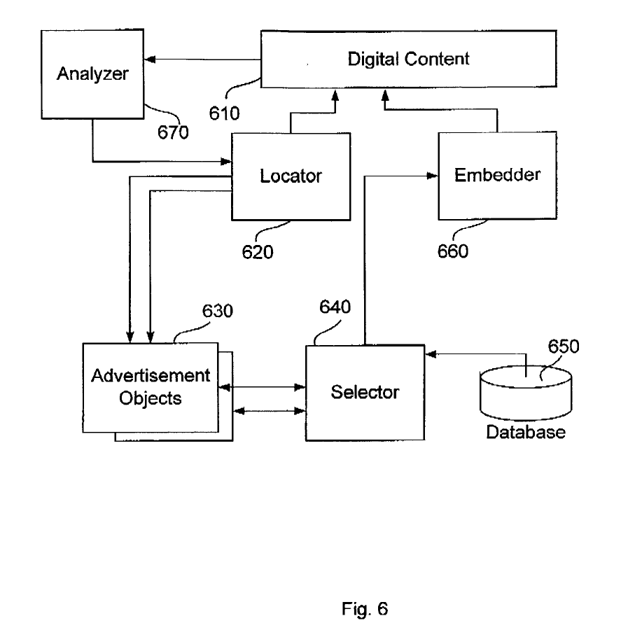

FIG. 6 is a schematic illustration of a system for on-line embedding of a system for customized product placement, constructed and operative in accordance with a preferred embodiment of the present invention: the digital content 610 is analyzed by a locator 620 in order to locate potential spots for advertisement objects 630. A selector 640 selects which of the advertisement objects is embedded in each of the slots, possibly by utilizing demographic data and other side-information usually stored in database 650. An embedder 660 then embeds the selected advertisement object in the selected spot, in a manner designed to allow the embedded material to be perceived as an integral part of the digital content. An analyzer 670 may be used by the locator 620 to analyze the content and provide information for performing the locating. The locator 620 is usually (but not necessarily) manually controlled, because of the complex operations, and the sensitive nature of the result. The manual control may consist of the actual location or approval and classification of locations.

The selector 640 usually performs the selection in a manner that optimizes at least one of the following:

the effectiveness of the advertising, the effect of the embedding of the advertisement objects on the value of the content, the effect of the embedding of the advertisement objects on the realism of the content, the effect of the embedding of the advertisement objects on the experience of viewing the content and the value of embedding the advertisement objects.

The information that is usually stored in the database 650 usually includes information about:

the viewers of the content, the preferences of the viewers of the content, the preferences of the advertisers, the demographics of the viewers of the content, the subject of the content, the content of the content, the atmosphere induced by the content, the content of the advertisement, the interests of the viewers of the content, and the advertised products.

The selection can also be used to store information, usually forensic information utilizing a method similar to the one described in PCT application number IL01/00923, titled “A Method and System for Distributing Digital Content with an Embedded Message”.

Customization of product placement in e-books is relatively straightforward, since creating versions of text with various brands is a rather straightforward task, (e.g.: “Secret-agent 707 took a long gulp from his ice-cold x-cola, kissed the beautiful girl goodbye and drove his exquisite y-car to the exclusive z-hotel”). Post-production versioning of brands in movies is harder. However, current technology allows efficient post-production placement. The following patents and patents applications describe several methods that can be useful for practicing preferred embodiments of the present invention:

U.S. patent application no. 20010001242 suggests a virtual studio position sensing system. In the disclosure a position detecting method for an object within a virtual set involves providing the object with an emitting device and using the device in conjunction with a plain or patterned chroma-key background to provide the exact position of a TV camera. Alternatively the positioning device may bc used alone, that is without an accompanying background, to provide a position for another object or actor.

U.S. Pat. No. 6,122,013 is a Chromo-keying system, including a store that contains a representation of a known coded chromo-keying pattern. The system further includes a frame grabber that grabs a video image including at least a portion of the known coded chromo-keying pattern and a foreground subject. A perspective transformation computation unit computes a perspective transformation by comparing the video image of the portion of the coded chromo-keying pattern with the known chromo-keying pattern. The system may further include a background generation unit that receives a background image and applies the perspective transformation to the background image to produce a transformed background. The portion of the coded chromo-keying pattern in the video image can then be replaced by the transformed background to create a composite image. In the case of layer enabled content (e.g. MPEG-4), the replaced elements may be stored in a different layer, e.g. a different Video Object Plane (VOP). Nevertheless, the replaced elements may be stored in the same file.

U.S. Pat. No. 5,903,317 describes an apparatus and method for detecting, identifying and incorporating advertisements into video content. The system can be utilized for video transmission of active events, e.g., sports events, having in the background physical images in designated targets, wherein the physical images are electronically exchanged with pre-selected virtual images, so that objects or shadows actually blocking portions of the physical images may be seen by viewers as blocking the same portions of the virtual images, and the motion of players or a ball blocking the physical image may block corresponding regions of the exchanged virtual images, so that the exchange electronic image remains in the background of the event exactly as does the original image.

In the case of visual content generated by computer, and based on a three dimensional object model, replacing an object is easier if done before the rendering stage, although it is possible to combine two previously rendered scenes. The object may have its own three-dimensional representation, which is used as a part of a scene, requiring at least part of the rendering to be done several times. If the objects are similar in shape, or when the model of the scene is dynamic enough for the objects to realistically interact with one another, modeling and replacing the objects may be the only non automatic action necessary for such a replacement. Thus, for example, when a character holds a can the model may automatically fit the character's grip to the shape and physical characteristics of the can.

In the case of non-generated content, or when the model is not available, it may still be beneficial to produce such a three dimensional model. The model thus created need only be partial, which is to say it is only necessary to model what is necessary for the replacement. Techniques such as movement detection and image matching may be used to distinguish between objects and partly model them as three dimensional objects when they change orientation or interact with other objects. Lighting sources can be traced by analyzing shadow and reflection patterns, and object properties (such as reflection model, and transparency), can be similarly discerned. The above described procedure may thus allow replacement of an object with a three-dimensional model of another object (or insertion of such an other object) in a realistic manner, that is to say consistent with other objects' positions, lighting and shadows in the scene, using known image processing techniques.

It is appreciated that features mentioned herein in the context of certain embodiments may be applied to other embodiments, and embodiments described with various features may also be considered without those features insofar as a working embodiment is retained.

It is appreciated that one or more steps of any of the methods described herein may be implemented in a different order than that shown, while not departing from the spirit and scope of the invention.

While the present invention may or may not have been described with reference to specific hardware or software, the present invention has been described in a manner sufficient to enable persons having ordinary skill in the art to readily adapt commercially available hardware and software as may be needed to reduce any of the embodiments of the present invention to practice without undue experimentation and using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, arc nevertheless within the true spirit and scope of the invention.

We claim:

1. A method for dynamic embedding of objects into context selectable locations in digital media items to form versions of said digital media items, said method comprising the steps of:
finding context suitable locations in said visual media;
dynamically selecting a subset of said objects for at least one location; and
embedding one object of said subset of objects in said at least one location, thereby to form a version of said digital media item.

2. A method according to claim 1, wherein said object comprises visual representation of at least one of the following:
a product;
a logo;
the name of a product;
the name of a company;
a text related to a product;
a text related to a company;
an object related to a company; and
an object related to a product.

3. A method according to claim 1, wherein said digital media item is video.

4. A method according to claim 1, wherein said digital media item is a still image.

5. A method according to claim 3, wherein said location includes a location in time and a geometric location, said location in time being a subset of the duration of said video.

6. A method according to claim 1, wherein at least one of said locations comprises an existing object within said visual content, and wherein said object being embedded, replaces said existing object.

7. A method according to claim 1, wherein at least one of said objects is a void object designed to be used when no other object is selected for said location.

8. A method according to claim 1, wherein said object selection is additionally for representing information.

9. A method according to claim 8, wherein said information comprises forensic information.

10. The method of claim 1, wherein said digital media is any one of a group comprising: video, still image, audio, and written media.

11. A method according to claim 1, wherein said selection is based on information about at least one the following:
viewers of said visual content;
preferences of viewers of said visual content;
preferences of advertisers;
demographics of the viewers of said visual content;
subject-matter of said digital media item;
atmosphere induced by said digital media item;
content of said objects to be embedded;
interests of viewers of said digital media item; and
products being the subject of said objects to be embedded.

12. A method according to claim 11, wherein at least some of said information is stored in a database.

13. A method according to claim 1, comprising preparing alternative versions of said digital media item by making alternative object selections for each version.

14. A method according to claim 1, wherein said digital media is arranged in layers, and wherein at least some of said advertisement objects are embedded in separate layers.

15. A method according to claim 1, wherein said digital media is at least partially generated by computer, based on scene representation, wherein at least some of said objects to be embedded are also based on a scene representation, and wherein at least some of said generating is done after the embedding of said objects.

16. A method according to claim 15, wherein said scene representation comprises at least one of the following:
a three dimensional scene representation;
an object based representation;
an object based representation which further comprises interaction between objects; and
an object based representation which further comprises physical interaction between objects.

17. A method according to claim 1 wherein said method further comprises the steps of:
analyzing said visual content;
locating at least one replaceable object in said visual content;
selecting at least one replaceable object in said visual content; and
embedding said objects to be embedded by replacing at least some of said replaceable objects with said objects to be embedded.

18. A method according to claim 17, wherein said analyzing comprises analyzing at least one of the following properties:
lighting;
shading;
texture;
object orientation and location;
relative object location;
object movement;
frame panning;
frame zooming;
frame rotation;
refraction;
transparency;
focus; and
reflection,
and wherein the step of embedding said advertisement objects by replacing said replaceable objects is done in a manner optimizing the retention of at least some of said properties, thereby to enhance the realism in the produced visual content.

19. A method according to claim 17, wherein at least one of said advertisement objects is represented by a three dimensional model.

20. A system for dynamic embedding of at least one embeddable object in digital media, wherein said embeddable object is to be embedded in a manner designed to be perceived as an integral part of said digital media and thereby to form different versions of said digital media, said system comprising:
a locator operable to find at least one location in said visual content contextwise suitable for objects of a group to which said embeddable object belongs;
a selector operable to dynamically select objects from said group; and
an embedding mechanism operable to embed said selected object in said contextwise suitable location.

21. A system according to claim 20, wherein said embeddable object comprises visual representation of at least one of the following:
a product;
a logo;
the name of a product;
the name of a company;
a text related to a product;
a text related to a company;
an object related to a company; and
an object related to a product.

22. A system according to claim 20, wherein said digital media is video.

23. A system according to claim 20, wherein said digital media is a still image.

24. A system according to claim 22, wherein said location includes a location in time and a geometric location, said location in time being a subset of the duration of said video content.

25. A system according to claim 20, wherein at least one of said locations comprises an included object in said digital media, and wherein said advertisement object, when embedded in said location, replaces said object.

26. A system according to claim 20, wherein at least one of said embeddable objects is a null object designed to be used when no other object is selected for said location.

27. A system according to claim 20, wherein said selector is further operable to make said selection to represent information.

28. A system according to claim 27, wherein said information comprises forensic information.

29. A system according to claim 20, wherein the selection done by said selector is based on information about at least one the following:
viewers of said digital media;
preferences of viewers of said digital media;
preferences of advertisers;
demographics of viewers of said digital media;
subject-matter of said digital media;
content of said digital media;
atmosphere induced by said digital media;
content of said embeddable objects;
interests of viewers of said digital media; and
products which are the subjects of said embeddable objects.

30. A system according to claim 29, further comprising a database operable to store at least some of said information.

31. A system according to claim 20, operable to prepare several versions of at least part of said digital media by embedding different ones of said embeddable objects.

32. A system according to claim 20, wherein said digital media comprises layers, and wherein at least some of said embeddable objects are embedded in separate layers.

33. A system according to claim 20, wherein said visual content is at least partially generated by computer based on scene representation, wherein at least some of said embeddable objects are also based on a scene representation, wherein said visual content is created by generating said scene representation and wherein at least some of said generating is done after the embedding of said advertisement objects by said embedding mechanism.

34. A system according to claim 33, wherein said scene representation comprises at least one of the following:
a three dimensional scene representation;
an object based representation;
an object based representation which further comprises interaction between objects; and
an object based representation which further comprises physical interaction between objects.

35. A system according to claim 20, further comprising an analyzer for analyzing said visual content, wherein said locator is operable to locate at least one replaceable object in said digital media based on information provided by said analyzer, wherein said selector is operable to select located replaceable object in said digital media, and wherein said embedding mechanism is operable to embed said embeddable object by replacing at least some of said replaceable objects with said embeddable object.

36. A system according to claim 35, wherein said analyzer is operable to analyze for at least one of the following properties:
lighting;
shading;
texture;
object orientation and location;
relative object location
object movement;
frame panning;
frame zooming;
frame rotation;
refraction;
transparency;
focus; and
reflection,
and wherein the embedding by said embedding mechanism is done in a manner optimizing the retention of at least some of said properties, thereby to enhance realism of the embedding.

37. A system according to claim 35, wherein at least one of said embeddable objects is represented by a three dimensional model.

38. A method for dynamic embedding of at least one embeddable object into verbal digital media content, wherein said embeddable object is embedded in a manner designed to be perceived as an integral part of said verbal content, said method comprising the steps of:
finding at least one location in said digital verbal content which is contextwise associable with a type of object;
dynamically selecting an embeddable object being of said type; and
embedding said selected embeddable object in said contextwise associable location.

39. A method according to claim 38, wherein said embeddable objects comprises verbal representation of at least one of the following:
the name of a product;
the name of a company;
a text related to a product; and
a text related to a company.

40. A method according to claim 38, wherein said verbal content is audio content.

41. A method according to claim 38, wherein said verbal content is textual content.

42. A method according to claim 38, wherein at least one of said locations comprises an existing object within said verbal content, and wherein said embeddable object, when embedded in said location, replaces said existing object.

43. A method according to claim 38, wherein at least one of said advertisement objects is a null object designed to be used when no advertisement object is selected for said location.

44. A method according to claim 38, wherein said selecting is further operable to represent information.

45. A method according to claim 44, wherein said information comprises forensic information.

46. A method according to claim 38, wherein said selection is based on information about at least one the following:
users of said verbal content;
preferences of the users of said verbal content;
preferences of advertisers;
demographics of users of said verbal content;
subject-matter of said verbal content;
atmosphere induced by said verbal content;
content of said embeddable objects;
interests of users of said verbal content; and
products represented by said embeddable objects.

47. A method according to claim 46, wherein at least some of said information is stored in a database.

48. A method according to claim 38, wherein several versions of at least part of said verbal content are prepared by embedding different objects therein.

49. A method according to claim 38, wherein said verbal content comprises layers, and wherein at least some of said objects are embedded in separate layers.
